(19) United States
(12) Patent Application Publication
(10) Pub. No.: US 2019/0050837 A1
(43) Pub. Date: Feb. 14, 2019

(54) METHOD FOR CONTROLLING ACCESS TO POINTS OF SALE

(71) Applicant: INTERNATIONAL BUSINESS MACHINES CORPORATION, ARMONK, NY (US)

(72) Inventors: Gianluca Della Corte, Rome (IT); ALESSANDRO DONATELLI, Rome (IT); MARCO MARTINO, Rome (IT); Antonio Sgro', Fiumicino (IT)

(21) Appl. No.: 15/673,465

(22) Filed: Aug. 10, 2017

(51) Int. Cl. G06Q 20/20; G06F 21/32; G06K 9/00

(52) U.S. Cl. CPC G06Q 20/206; G06F 21/32; G06K 9/00335; G06K 9/00288; G06K 9/00771; G06K 9/00255

(57) ABSTRACT

The present disclosure relates to a method for controlling access to a group of points of sale. A database is provided. The database comprises behavioral data of a plurality of users in association with facial identities of the users. The behavioral data of a user indicates one or more products and behaviors of the user toward the one or more products. The method comprises: determining a facial identity of a given user using a predefined facial recognition method. The behavioral data associated with the determined facial identity may be read from the database. Points of sale of the group points of sale that correspond to the products indicated in the read behavioral data may be selected.

### BACKGROUND

The present invention relates to the field of digital computer systems, and more specifically, to a method for controlling access to points of sale. Today, with many major malls and shopping centers, it is quite complex to coordinate the access of users in such buildings so that the users can move smoothly and safely. In particular, there is a technical need for a systematic well-planned user flow in such buildings.

### SUMMARY

Various embodiments provide a method for controlling access to points of sale, computer system, monitoring device and computer program product as described by the subject matter of the independent claims. Advantageous embodiments are described in the dependent claims. Embodiments of the present invention can be freely combined with each other if they are not mutually exclusive. In one aspect, the invention relates to a method for controlling access to a group of points of sale. The method comprises: providing a database comprising behavioral data of a plurality of users in association with facial identities of the users, the behavioral data of a user indicating one or more products and behaviors of the user toward the one or more products; determining a facial identity of a given user using a predefined facial recognition method; reading from the database the behavioral data associated with the determined facial identity; selecting points of sale of the group points of sale that correspond to the products indicated in the read behavioral data; rating the selected points of sale using the behavioral data of the given user; using the rates for controlling (e.g. automatically controlling) access to the group of points of sale by the given user.

In another aspect, the invention relates to a computer program product comprising a computer-readable storage medium having computer-readable program code embodied therewith, the computer-readable program code configured to implement all of steps of the method according to preceding embodiments.

In another aspect, the invention relates to a computer system for controlling access to a group of points of sale. The computer system comprises a database comprising behavioral data of a plurality of users in association with facial identities of the users. The behavioral data of a user indicates one or more products and behaviors of the user toward the one or more products. The computer system is configured for: determining a facial identity of a given user using a predefined facial recognition method; reading from the database the behavioral data associated with the determined facial identity; selecting points of sale of the group points of sale that correspond to the products indicated in the read behavioral data; rating the selected points of sale using the behavioral data of the given user; using the rates for automatically controlling access to the group of points of sale by the given user.

In another aspect, the invention relates to a monitoring device. The monitoring device is configured for: tracking behaviors of a user toward one or more products; evaluating one or more position parameters of the user; and sending behavioral data comprising the evaluated position parameter and the one or more products to the computer system. The monitoring device may for example comprise a camera.

### BRIEF DESCRIPTION OF THE SEVERAL VIEWS OF THE DRAWINGS

In the following embodiments of the invention are explained in greater detail, by way of example only, making reference to the drawings in which:

FIG. 1 represents a general computerized system in connection with a group of points of sale.

FIG. 2 is flowchart of a method for controlling access to a group of points of sale or stores.

FIG. 3 is a block diagram of components of a computing device in accordance with embodiments of the present invention.

FIG. 4 depicts a cloud computing environment according to an embodiment of the present invention.

FIG. 5 depicts abstraction model layers according to an embodiment of the present invention.

### DETAILED DESCRIPTION

The descriptions of the various embodiments of the present invention will be presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. The group of points of sale may be part of a building. The group of points of sale may comprise a shopping center, mall, airport hub, multipurpose complex etc. Such buildings may receive several hundreds of visitors or users which may lead to random flows causing unsafe movements of the users. With the present method, the real time analysis and evaluation of the user behaviors may enable a real-time reaction to adjust or organize the user accesses in particular the user flows in the group of points of sale. This may maximize user distributions in the building of the group of points of sales.

The present solution provides a cognitive method to control access to the group of points of sales using the relevant information needed to figure out which are the goods a user is interested in. The user is just recognized and classified based on his activities while doing shopping just as a masked buyer (e.g. no personal accounts of the user). The present system may enable synchronization between all shops or points of sale in a well-defined area (e.g. a street, a shopping center, etc.) so that all the shops can collect user information and the system will merge input to provide the right advertisers to the user.

As the method of the invention uses cameras performing face recognition, the data collected are instantly used and then destroyed and the individuals/group of people concerned have been advised. According to one embodiment, providing the database comprises: receiving the behavioral data from cameras of the group of points of sale and/or from cameras of another group of points of sale, and building the database using the received behavioral data. Building the database from multiple different groups of points of sales may enhance the content of the database which may thus enable an efficient and accurate access control to the group of points of sale. For example, after the given user has entered the groups of points of sale, the behavioral data obtained by cameras of the visited points of sale may be added to the database in association with the facial identity of the given user. This may provide a continuous update of the database, which may further improve the efficiency of the access control to the groups of points of sales.

According to one embodiment, the behavioral data comprises values of a position parameter indicating the behaviors of the users. The position parameter comprises at least one of: the time spent by a user within a predefined distance to a product of a given point of sale; the number of times the user has been within the predefined distance; and the number of times the user has not been in the predefined distance while being in the given point of sale. The values of the position parameter may be evaluated by the computer system based on the received data from the cameras. In another example, the position parameter may be evaluated by the cameras. This embodiment may be advantageous as it may increase the accuracy of the control of accesses to the group of points of sale. This may further optimize and maximize user distributions in the building of the groups of points of sale.

According to one embodiment, the behavioral data comprises values of a position parameter. The rating comprises: comparing the parameter values of the products indicated in the read behavioral data; and based on the comparison results, assigning scores to the selected points of sale. This may provide a systematic method for automatically controlling the access to the group of points of sale. Depending on the parameter types, the parameter values may for example be ranked and assigned to the corresponding points of sales. According to one embodiment, the rating of the selected points of sale comprises: evaluating the following function for each product indicated in the behavioral data:

$${F}_{i , j} = \frac{{N}_{j} * T}{{M}_{j}}$$

where i is the given user, j is the product, N is the number of times user i is in a predefined distance of the product j, T is the time spent by user i in looking at product j within the predefined distance, M is the number of times user i has not been in the predefined distance while being in the given point of sale; and assigning scores to the points of sale using the values of the function.

For example, the higher the value of the function of a given product, the higher the score of the point of sale that provides the product. In one example, the value of the function for a given product may be used as the score of the point of sale that provides the product. If for example, more than one product in the read behavioral data is provided by the same point of sale, the sum of their respective values of the function may be used as the score for that same point of sale. This embodiment may further increase the accuracy of the selected points of sales and the resulting control of accesses to the group of points of sale. According to one embodiment, the controlling comprises: displaying a ranked list of the selected points of sale, wherein the ranking is based on the rates. For example, based on the ranked list the user may be enabled or guided to access the points of sales in their order in the ranked list. For example, the computer system may further generate and display an itinerary to be followed by the user for accessing the ranked points of sale. According to one embodiment, the ranked list comprises only points of sale fulfilling a predefined access condition. For example, the method may be repeated for other users, resulting in other ranked lists. In this case, the access condition comprises: the point of sale is part of a number of ranked lists that is smaller than a predefined threshold. In other terms, if a point of sale is suggested for a high number of users this may cause hot spots or critical points within the building of the group of points of sale. This embodiment may provide control for such situations.

According to one embodiment, the controlling comprises: enabling access to the first N ranked points of sale only, wherein N is smaller than a predefined threshold. The ranked list may for example be used for enabling the given user to access only the N (e.g. N=2) highest ranked points of sales. This may for example improve the users flow in the group of points of sales by limiting the number of stores where the given user can access. For example, the access to the point of sales may be through automatic doors that can be opened or closed for the given user based on whether they are among the N points of sale.

According to one embodiment, the controlling comprises generating guidance information on at least one display screen relating to locations of the selected points of sale. The guidance may comprise for example an itinerary to be followed by the user. This may for example be done by identifying by the computer system low-traffic areas and flow patterns and based on those identified low-traffic areas and flow patterns, the computer system may generate the guidance accordingly. For example, if the user can follow more than one itinerary in order to reach the points of sales in the ranked list, one of the two itineraries may be selected based on the identified low-traffic areas and flow patterns.

According to one embodiment, selecting points of sale of the group points of sale is performed using a product database, wherein the product database comprises data indicative of products in association with points of sale.

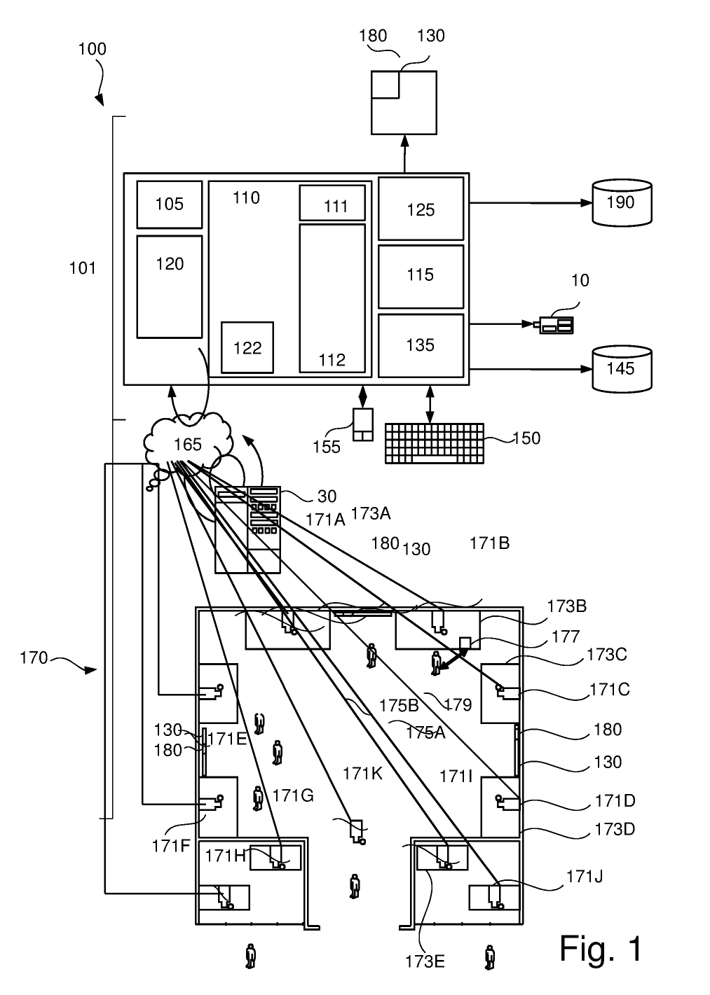

FIG. 1 represents a general computerized system or a server system 100, suited for implementing method steps as involved in the disclosure. It will be appreciated that the methods described herein are at least partly non-interactive, and automated by way of computerized systems, such as servers or embedded systems. In exemplary embodiments though, the methods described herein can be implemented in a (partly) interactive system. These methods can further be implemented in software 112, 122 (including firmware 122), hardware (processor) 105, or a combination thereof. In exemplary embodiments, the methods described herein are implemented in software, as an executable program, and is executed by a special or general-purpose digital computer, such as a personal computer, workstation, minicomputer, or mainframe computer. The most general system 100 therefore includes a general-purpose computer 101.

In exemplary embodiments, in terms of hardware architecture, as shown in FIG. 1, the computer 101 includes a processor 105, memory (main memory) 110 coupled to a memory controller 115, and one or more input and/or output (I/O) devices (or peripherals) 10, 145 that are communicatively coupled via a local input/output controller 135. The input/output controller 135 can be, but is not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components. As described herein the I/O devices 10, 145 may generally include any generalized cryptographic card or smart card known in the art.

The processor 105 is a hardware device for executing software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing software instructions. The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM). Note that the memory 110 can have a distributed architecture, where various components are situated remote from one another, but can be accessed by the processor 105.

The software in memory 110 may include one or more separate programs, each of which comprises an ordered listing of executable instructions for implementing logical functions, notably functions involved in embodiments of this invention. In the example of FIG. 1, software in the memory 110 includes instructions or software 112 e.g. instructions to manage databases such as a database management system. The software in memory 110 shall also typically include a suitable operating system (OS) 111. The OS 111 essentially controls the execution of other computer programs, such as possibly software 112 for implementing methods as described herein.

The methods described herein may be in the form of a source program 112, executable program 112 (object code), script, or any other entity comprising a set of instructions 112 to be performed. When a source program, then the program needs to be translated via a compiler, assembler, interpreter, or the like, which may or may not be included within the memory 110, so as to operate properly in connection with the OS 111. Furthermore, the methods can be written as an object oriented programming language, which has classes of data and methods, or a procedure programming language, which has routines, subroutines, and/or functions. In exemplary embodiments, a conventional keyboard 150 and mouse 155 can be coupled to the input/output controller 135. Other output devices such as the I/O devices 145 may include input devices, for example but not limited to a printer, a scanner, microphone, and the like. Finally, the I/O devices 10, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The I/O devices 10, 145 can be any generalized cryptographic card or smart card known in the art. The system 100 can further include a display controller 125 coupled to one or more displays 130.

The coupling may for example be via a bus and/or via network 165. In exemplary embodiments, the system 100 can further include a network interface for coupling to a network 165. The network 165 can be an IP-based network for communication between the computer 101 and any external server, client and the like via a broadband connection. The network 165 transmits and receives data between the computer 101 and external systems 30, which can be involved to perform part or all of the steps of the methods discussed herein. In exemplary embodiments, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals. In another example, the network 165 may be an Ethernet network.

If the computer 101 is a PC, workstation, intelligent device or the like, the software in the memory 110 may further include a basic input output system (BIOS) 122. The BIOS is a set of essential software routines that initialize and test hardware at startup, start the OS 111, and support the transfer of data among the hardware devices. The BIOS is stored in ROM so that the BIOS can be executed when the computer 101 is activated. When the computer 101 is in operation, the processor 105 is configured to execute software 112 stored within the memory 110, to communicate data to and from the memory 110, and to generally control operations of the computer 101 pursuant to the software.

The methods described herein and the OS 111, in whole or in part, but typically the latter, are read by the processor 105, possibly buffered within the processor 105, and then executed. When the systems and methods described herein are implemented in software 112, as is shown in FIG. 1, the methods can be stored on any computer readable medium, such as storage 120, for use by or in connection with any computer related system or method. The storage 120 may comprise a disk storage such as HDD storage. Multiple cameras 171A-N of a groups of points of sale 170 may connect to the server system 100 via network 165. The cameras 171A-N are installed in stores or points of sale 173A-N. Each of the points of sale 173A-N may provide or comprise products such as goods and services. For example, the point of sale 173B is shown as comprising product 177.

The cameras 171A-N may be frame or video-based cameras. Cameras 171A-N are configured to perform facial recognition and tracking movements of the users 175A-N e.g. with respect to products provided by the points of sale. For example, cameras 171A-N are configured for tracking or monitoring users 175A-N in the respective points of sale in order to collect behavioral data of the users 175A-N. The behavioral data indicates the behaviors of the user toward the products. The face or facial recognition may be performed by the cameras 171A-N using one or more face recognition techniques such as Robust Face Detection Using the Hausdorff Distance, Model-based Face Tracking and three-dimensional face recognition. The facial recognition technique is a technique is an application capable of identifying or verifying a user from a digital image or a video frame from a video source. One of the ways to do this is by comparing selected facial features from the image and a face database. The face recognition of a given user 175A-N may result in determining a facial identity of the user. The facial identity may be a unique identifier of the user.

The information collected by the cameras 171A-N are associated with the facial identity of each monitored user 175A-N. The cameras 171A-N may for example comprise recording means for recoding acquired videos and processing means for processing the videos. The cameras 171A-N may be configured for processing recorded videos (e.g. to obtain position parameter values and facial identities). The cameras may be configured for sending the videos and/or processed data to the computer system 100.

In one example, the behavioral data collected for a monitored user 175A for the first time by a camera 171A may locally be stored in the camera 171A in association with the facial identity of the user 175A. If the user 175A is detected again by the same camera 171A, the facial identity may be determined and the newly collected information may be added to the existing information of the same user 175A. This may be performed until a predefined size of data for the user 175A is reached e.g. N Gigabytes of data. Upon reaching the predefined size of data, the camera 171A may be configured to send the behavioral data of the user 175A to the computer system 100 or to store such data in the database 190. In another example, the behavioral data collected for a monitored user 175A by a camera 171A may be sent immediately after the monitoring of the user ends (e.g. when the user is not detectable by the camera) in association with the facial identity of the user 175A to the computer system 100 or may be stored on the database 190. The computer system 100 may store the received behavioral data from the cameras in the database 190.

Each camera 171A-N is configured to track the users 175A-N by for example determining the positions of the users 175A-N with respect to one or more products in the point of sale where the camera is installed. For example, the camera may register and determine the distance of the user to each product in the point of sale. For example, the user 175A is at a distance 179 of the product 177. This distance 179 indicates that the user is interested in product 177. In addition, the camera may determine the direction of the face of the user with respect to a product in the point of sales (e.g. it may determine whether the user is looking to the product or not).

For example, when a user enters or approximates a shop, the camera 171A-N will recognize the user or if it is a new user will create a new entry (e.g. in the database 190) associating a generic ID to the user himself (an ID associated to a face). If the user is new or not, the cameras 171A-N within the shops will recognize all things that user is looking at and things that he never looks (he may not be interested at all and so he skips quickly many things). For example, the camera will record time spent in looking to interesting goods. The collected behavioral information and received by the computer system 100 may be stored in a database 190 to which the computer system 100 has access. The database 190 may or may not be part of the computer system 100. The database 190 may for example comprise for each monitored user, the facial identity of the user and the behavioral information received from the cameras 171A-N for that user.

FIG. 1 provides multiple cameras 171A-N which may be installed on multiple locations on a shop window and inside the shop close to the shelf. Monitors or displays 130 project spots about specific goods which are targeted for specific users. Each monitor or display may have its own camera 180 to identify who is looking to the monitor itself. A recording software component that stores identified users through the face recognition and their interests (things that look for and shops they visited) may be part of the cameras 171A-N and/or computer system 100. An advertising cognitive component of the computer system may use all stored data coming from multiple shops into the same well defined area to propose the content to the specific user.

For simplicity of the description, the computer system 100 is shown connected to a single group of points of sale 170; however, the computer system 100 is configured to receive behavioral data as described above from other groups of points of sales. The computer system 100 may further be coupled to one or more cameras 180 e.g. such as cameras 171A-N. The cameras 180 may for example be installed on the displays 130. The displays 130 may for example be part of the group of point of sales 170. The displays 130 may be positioned such that each user willing to access the group of points of sale may be in front of the display 130 before going to other points of sale in the group of points of sale 170.

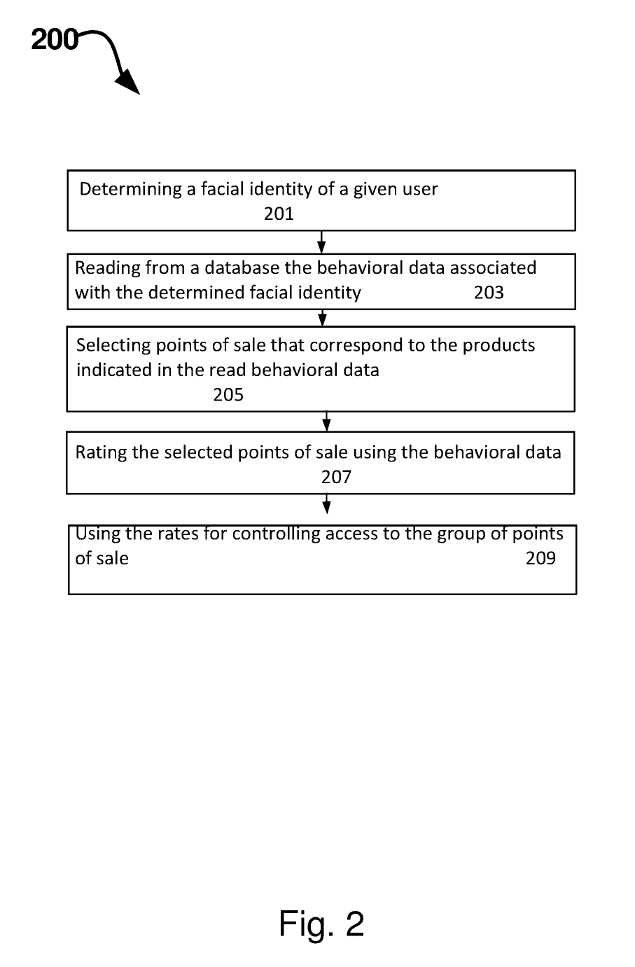

FIG. 2 illustrates flowchart 200 of a method for controlling access to a group of points of sale or stores e.g. 175A-N. The group of points of sale may comprise a shopping center, mall, airport hub, multipurpose complex etc. For example, one or more users are willing to access the group of points of sale 170. However, since the number of users wiling to access the group of points of sales may be high, there is a need for controlling the access to the group of points of sales e.g. in an automatic manner This may enable a controlled and secure access to the group of points of sale 170.

The group of points of sale (or group of shops) may be located in the same shopping center or in the same route. This may allow to have enough cognitive information for better performance of the present method. In step 201, a facial identity of a given user (e.g. 175A) may be determined using a predefined facial recognition method of the facial recognition methods described above. For example, the given user 175A may be willing to visit or access one or more points of sale in the group of points of sale 170. For that, the facial identity may be determined by the camera 180 and/or the computer system 100. For example, the display 130 is positioned (e.g. in a main entrance of the group of points of sale 170) such that the user 175A has to be first in the front of the display 130 before going anywhere else in the group of points of sale 170. As shown in FIG. 1, the user 175B is in front of the display 130 before accessing the points of sale 173A-N. For example, the camera 180 may send video signals to the computer system 100 that records the received signals. The computer system 100 may determine the facial identity (or facial features) from the video signals.

In step 203, the behavioral data associated with the determined facial identity of step 201 may be read from the database 190. For example, the computer system 100 may be configured to read the database 190 to identify entries that relate to the determined facial identity of the user 175A. In step 205, points of sale of the group points of sale 170 that correspond to the products indicated in the read behavioral data may be selected. The behavioral data of the user 175A that is read in step 203 indicates one or more products and the behaviors of the user toward the one or more products.

For example, the one or more products may comprise a mobile phone, shoe etc. The computer system 100 may for example identify the selected points of sale using a product database (e.g. 145) that stores the products in association with the points of sales that provide such products. By reading the product database 145, the computer system 100 may determine among points of sale of the group 170 the points of sale that provide the products indicated in the behavioral data read in step 203. If for example, the products in the behavioral data of step 203 comprise a mobile phone, a telecommunication point of sale may be selected from the product database.

In step 207, the selected points of sale of step 205 may be rated using the behavioral data of the user 175A. Each of the selected points of sale may be assigned a score indicative of its relevance for the user 175A. For example, the more the user is interested in a product 177 the higher the score associated to the point of sale 173B that provides the product 177. The interest of the user to a product may for example be quantified by the frequency of accessing that product or the time spent in front of that product.

For example, the behavioral data comprises data indicating the time spent by the user 175A within a predefined distance 179 to each of the one or more products 177 e.g. the time spent by the user 175A in front of the mobile phone within a distance of 40 cm. The behavioral data may further indicate the number of times the user 175A has been within the predefined distances 179 to each of the one or more products 177. The behavioral data may further indicate the number of times the user 175A has not been in the predefined distance of the one or more products while being in the point of sale of the respective product.

In one example, the scoring or rating of the points of sale 173A-N may be performed by evaluating the following function for each product indicated in the read behavioral data of step 203:

$${F}_{i , j} = \frac{{N}_{j} * T}{{M}_{j}}$$

where i is the given user, j is the product, N is the number of times user i is in a predefined distance of the product j, T is the time spent by user i in looking at product j within the predefined distance, M is the number of times user i has not been in the predefined distance while being in the given point of sale. Scores may be assigned to the points of sale using the values of the function. For example, the higher the value of the function of a given product, the higher the score of the point of sale that provides the product. In one example, the value of the function for a given product may be used as the score of the point of sale that provides the product. If for example, more than one product in the read behavioral data is provided by the same point of sale, the sum of their respective values of the function may be used as the score for that same point of sale. This embodiment may further increase the accuracy of the selected points of sales and the resulting control of accesses to the group of points of sale.

In another example, the read behavioral data be a function of interested topics/associated time and a list of not interested topics for user_ID_X. An interest index of the user may be calculated using the function
Fi [(InterestedTopics,Time, NumberofTimes)(Not_InterestedTopics)] where i=user ID that can be used to return an ordered table by interest containing the goods observed by the user.
   Data collection and interest index calculation happens every time identified user looks at shopping showcases.

In step 209, the rates may be used for controlling access to the group of points of sale 170 (e.g. shopping center) by the user 175A. The control may for example automatically be performed in response to rating the selected points of sale. The control may for example comprise indicating or displaying an itinerary for the user 175A such that the user can follow the itinerary for accessing the points of sale in the ranked list e.g. in their order of ranking For example, the group of points of sale e.g. a shopping center may have multiple itineraries, wherein each of the itineraries may be accessed via an automatic door.

The control of step 209 may comprise enabling the user 175A to follow a single itinerary by opening only the door corresponding to that itinerary. In this way the users flow in the group of points of sale may be efficiently controlled. Steps 201-209 may be repeated for each user willing to access the group of points of sale 170. The present computer system that may be an advertising cognitive system using cameras may identify the users that are looking at an advertising monitor (e.g. 130) and will display spots (or points of sale or stores) that are in line with most important interests for the watching user, in particular will start showing spots related to the top of ordered table of interests followed by less interesting topics up to when the user will move on. The spots that are highlighted to the users are stored into a spot database (e.g. the product database 145) where companies post their spots and that are tagged per interest. In one example, based on how much companies pay for posting a specific post, the system will show to the users some or other spots that match the list of interests of a specific user. If there are multiple users looking at the same time, an intersection of interests based on the stored list of topics may be determined and only the intersection is projected in order to capture attention of the optimal number of users.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The above-described features may be combined in any way. For example, possible combination of features described above may be the following: claim 2 with claim 1, claim 3 with claim 1 or claim 2, claim 4 with any claim from 1 to 3, claim 5 with any claim from 1 to 4, claim 6 with any claim from 1 to 5, claim 7 with claim 6, claim 8 with claim 6 or claim 7, claim 9 with any claim from 1 to 8, claim 10 with any claim from 1 to 9, claim 11 with any claim from 1 to 10, claim 12 with instructions for performing the method of any claim from 1 to 11.

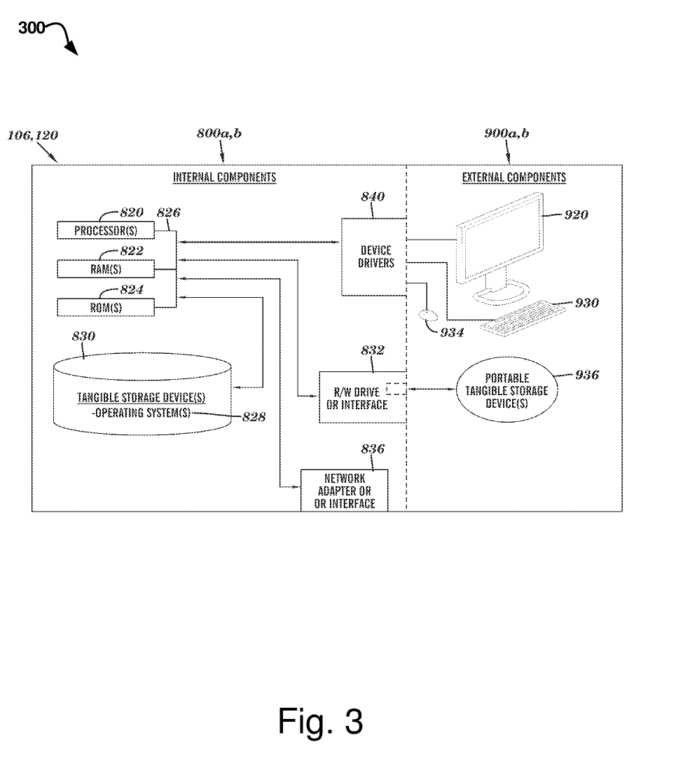

FIG. 3 is a block diagram 300 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

Aspects of the present invention may include respective sets of internal components 800a,b and external components 900a,b illustrated in FIG. 3. Each of the sets of internal components 800 include one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and the Software Program 108 (FIG. 1) and the Tape archive application 105 in client computing device 104 (FIG. 1) and the tape in Tape library 112 (FIG. 1) are stored on one or more of the respective computer-readable tangible storage devices 830 for execution by one or more of the respective processors 820 via one or more of the respective RAMs 822 (which typically include cache memory). In the embodiment illustrated in FIG. 6, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a,b also includes a R/W drive or interface 832 to read from and write to one or more portable computer-readable tangible storage devices 936 such as a CD-ROM, DVD, memory stick, magnetic tape, magnetic disk, optical disk or semiconductor storage device. A software program, such as the Software Program 108 (FIG. 1) can be stored on one or more of the respective portable computer-readable tangible storage devices 936, read via the respective R/W drive or interface 832 and loaded into the respective hard drive 830.

Each set of internal components 800a,b also includes network adapters or interfaces 836 such as a TCP/IP adapter cards, wireless Wi-Fi interface cards, or 3G or 4G wireless interface cards or other wired or wireless communication links The Software Program 108 (FIG. 1) and tape archive application 105 in client computing device 104 (FIG. 1) and the tape library controller 205 in tape library 112 (FIG. 1) can be downloaded to client computing device 104 (FIG. 1) and tape library 112 (FIG. 1) from an external computer via a network (for example, the Internet, a local area network or other, wide area network) and respective network adapters or interfaces 836. From the network adapters or interfaces 836, the Software Program 108 (FIG. 1) and tape archive application 105 in client computing device 104 (FIG. 1) and the tape library controller 205 in Tape library 112 (FIG. 1) in network server 114 (FIG. 1) are loaded into the respective hard drive 830.

The network may comprise copper wires, optical fibers, wireless transmission, routers, firewalls, switches, gateway computers and/or edge servers. Each of the sets of external components 900a,b can include a computer display monitor 920, a keyboard 930, and a computer mouse 934. External components 900a,b can also include touch screens, virtual keyboards, touch pads, pointing devices, and other human interface devices. Each of the sets of internal components 800a,b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

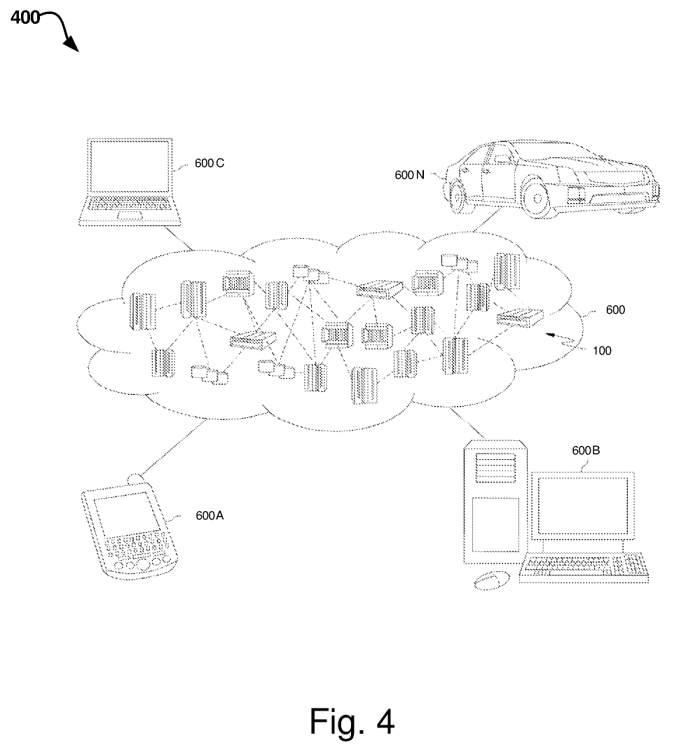

Referring now to FIG. 4, illustrative cloud computing environment 600 is depicted. As shown, cloud computing environment 400 comprises one or more cloud computing nodes 100 with which local computing devices used by cloud consumers, such as, for example, personal digital assistant (PDA) or cellular telephone 600A, desktop computer 600B, laptop computer 600C, and/or automobile computer system 700N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 400 to offer infrastructure, platforms and/or software as services for which a cloud consumer does not need to maintain resources on a local computing device. It is understood that the types of computing devices 600A-N shown in FIG. 7 are intended to be illustrative only and that computing nodes 100 and cloud computing environment 400 can communicate with any type of computerized device over any type of network and/or network addressable connection (e.g., using a web browser).

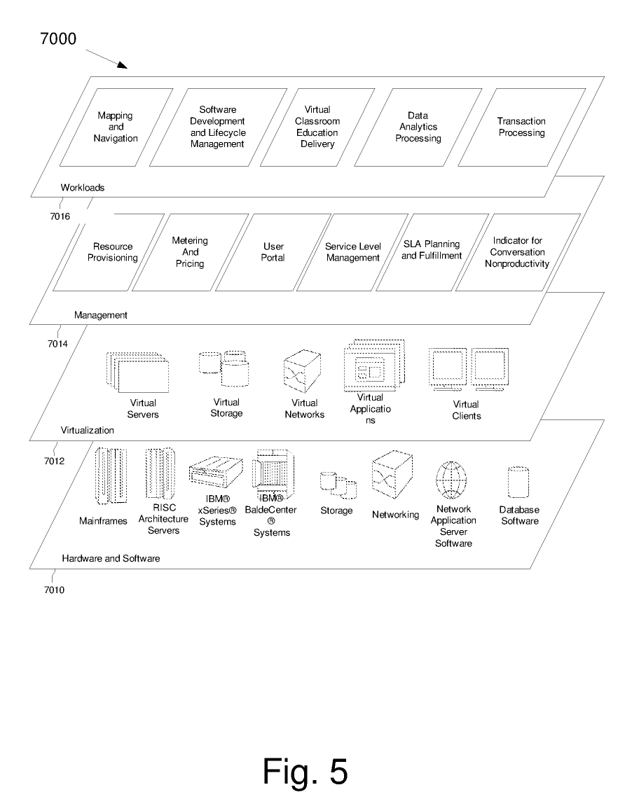

Referring now to FIG. 5, a set of functional abstraction layers 7000 provided by cloud computing environment 7000 (FIG. 5) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 7010 includes hardware and software components. Examples of hardware components include: mainframes; RISC (Reduced Instruction Set Computer) architecture based servers; storage devices; networks and networking components. In some embodiments, software components include network application server software.

Virtualization layer 7012 provides an abstraction layer from which the following examples of virtual entities may be provided: virtual servers; virtual storage; virtual networks, including virtual private networks; virtual applications and operating systems; and virtual clients.

In one example, management layer 7014 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User 106 portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. Workloads layer 7016 provides examples of functionality for which the cloud computing environment may be utilized. Examples of workloads and functions which may be provided from this layer include: mapping and navigation; software development and lifecycle management; virtual classroom education delivery; data analytics processing; and transaction processing.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for controlling access to a group of points of sale, the method comprising:
providing a database comprising behavioral data of a plurality of users in association with facial identities of the users, the behavioral data of a user indicating one or more products and behaviors of the user toward the one or more products;
determining a facial identity of a given user using a predefined facial recognition method;
reading from the database the behavioral data associated with the determined facial identity;
selecting points of sale of the group points of sale that correspond to the products indicated in the read behavioral data;
rating the selected points of sale using the behavioral data of the given user; and
using the rates for automatically controlling access to the group of points of sale by the given user.

2. The method of claim 1, providing the database comprising: receiving the behavioral data from cameras of the group of points of sale and/or from cameras of another group of points of sale, and building the database using the received behavioral data.

3. The method of claim 1, wherein the behavioral data comprises values of a position parameter indicating the behaviors of the users, the position parameter comprises at least one of:
the time spent by a user within a predefined distance to a product of a given point of sale;
the number of times the user has been within the predefined distance; and
the number of times the user has not been in the predefined distance while being in the given point of sale.

4. The method of claim 1, wherein the behavioral data comprises values of a position parameter, the rating comprising: comparing the parameter values of the products indicated in the read behavioral data.

5. The method of claim 1, further comprising assigning scores to the selected points of sale. based on the comparison results.

6. The method of claim 1, the rating comprising: evaluating the following function for each product indicated in the behavioral data.

7. The method of claim 1, the controlling comprising: displaying a ranked list of the selected points of sale, wherein the ranking is based on the rates.

8. A computer system for controlling access to a group of points of sale, the method comprising:
one or more processors, one or more computer-readable memories, one or more computer-readable tangible storage devices and program instructions which are stored on at least one of the one or more storage devices for execution by at least one of the one or more processors via at least one of the one or more memories, the program instructions comprising:
program instructions to provide a database comprising behavioral data of a plurality of users in association with facial identities of the users, the behavioral data of a user indicating one or more products and behaviors of the user toward the one or more products;
program instructions to determine a facial identity of a given user using a predefined facial recognition method;
program instructions to read from the database the behavioral data associated with the determined facial identity;
program instructions to select points of sale of the group points of sale that correspond to the products indicated in the read behavioral data;
program instructions to rating the selected points of sale using the behavioral data of the given user; and
program instructions to use the rates for automatically controlling access to the group of points of sale by the given user.

9. The computer system of claim 8, comprising: program instructions to receive the behavioral data from cameras of the group of points of sale and/or from cameras of another group of points of sale, and building the database using the received behavioral data.

10. The computer system of claim 8, wherein the behavioral data comprises values of a position parameter indicating the behaviors of the users, the position parameter comprises at least one of: the time spent by a user within a predefined distance to a product of a given point of sale; the number of times the user has been within the predefined distance; and the number of times the user has not been in the predefined distance while being in the given point of sale.

11. The computer system of claim 8, wherein the behavioral data comprises values of a position parameter, the rating comprising: comparing the parameter values of the products indicated in the read behavioral data.

12. The computer system of claim 8, further comprising assigning scores to the selected points of sale.

13. The computer system of claim 8, the rating comprising: evaluating the following function for each product indicated in the behavioral data.

14. The computer system of claim 8, the controlling comprising: displaying a ranked list of the selected points of sale, wherein the ranking is based on the rates.

15. A program product for customizing contextual information in a web conference presentation, the program product comprising:
one or more processors, one or more computer-readable memories, one or more computer-readable tangible storage devices and program instructions which are stored on at least one of the one or more storage devices for execution by at least one of the one or more processors via at least one of the one or more memories, the program instructions comprising:
program instructions to provide a database comprising behavioral data of a plurality of users in association with facial identities of the users, the behavioral data of a user indicating one or more products and behaviors of the user toward the one or more products;
program instructions to determine a facial identity of a given user using a predefined facial recognition method;
program instructions to read from the database the behavioral data associated with the determined facial identity;
program instructions to select points of sale of the group points of sale that correspond to the products indicated in the read behavioral data;
program instructions to rating the selected points of sale using the behavioral data of the given user; and
program instructions to use the rates for automatically controlling access to the group of points of sale by the given user.

16. The computer program product of claim 15, comprising: program instructions to receive the behavioral data from cameras of the group of points of sale and/or from cameras of another group of points of sale, and building the database using the received behavioral data.

17. The computer program product of claim 15, wherein the behavioral data comprises values of a position parameter indicating the behaviors of the users, the position parameter comprises at least one of: the time spent by a user within a predefined distance to a product of a given point of sale; the number of times the user has been within the predefined distance; and the number of times the user has not been in the predefined distance while being in the given point of sale.

18. The computer program product of claim 15, wherein the behavioral data comprises values of a position parameter, the rating comprising: comparing the parameter values of the products indicated in the read behavioral data.

19. The computer program product of claim 15, further comprising program instructions to assign scores to the selected points of sale.

20. The computer program product of claim 15, the rating comprising: program instructions to evaluate the following function for each product indicated in the behavioral data.
